(19) United States
(12) Patent Application Publication
(10) Pub. No.: US 2026/0160217 A1
(43) Pub. Date: Jun. 11, 2026

(54) SYSTEM AND RELATED METHODS FOR FUEL PRESSURE MONITORING

(71) Applicant: Caterpillar Inc., Peoria, IL (US)

(72) Inventor: Daniel R. PUCKETT, Peoria, IL (US)

(73) Assignee: Caterpillar Inc., Peoria, IL (US)

(21) Appl. No.: 18/908,463

(22) Filed: Oct. 7, 2024

(51) Int. Cl. F02D 41/38

(52) U.S. Cl. CPC F02D 41/3845; F02D 2200/0602

(57) ABSTRACT

A system and related methods for fuel pressure monitoring are described herein. The system may include an internal combustion engine, a plurality of fuel injectors, a fuel rail, a rail pressure sensor, and a controller. The plurality of fuel injectors may be configured to inject fuel into the internal combustion engine. The fuel rail may be configured to provide the fuel to the plurality of fuel injectors. The rail pressure sensor may be configured to detect a pressure of the fuel within the fuel rail. Further, the controller may be configured to (i) determine a rail pressure based on a signal from the rail pressure sensor; (ii) determined at least one pressure threshold; (iii) calculate a pressure error between the rail pressure and the at least one pressure threshold; and (iv) determine a high pressure condition based on the pressure error.

### TECHNICAL FIELD

The present disclosure relates generally to internal combustion engines, and more particularly, to a system for monitoring fuel injection in an internal combustion engine.

### BACKGROUND

Internal combustion engines are used in various types of machines, including mobile machines and stationary machines, to generate electrical power, provide power for propulsion, and operate implements. Internal combustion engines for industrial machines, in particular, generate power for long periods of time at high output levels by combusting fuel supplied via a fuel system. Over time, components of a fuel system wear and can even fail. For this reason, fuel pumps and fuel injectors of the fuel system are periodically replaced.

Catastrophic fuel system failures are rare and relatively easy to recognize. Irregularities, diminished performance, or minor failures in fuel systems, however, can be challenging to identify and diagnose. As a result, engine systems sometimes perform in a sub-optimal manner for extended periods of time. Irregularities or minor failures that result in sub-optimal engine performance may be particularly difficult to identify when the engine is experiencing transient conditions such as changes in load, vibration, amount of fuel delivered, change in desired rail pressure, and engine speed, etc. Irregularities or minor failures may also be difficult to identify when the engine is controlled according to other engine performance and emissions reduction strategies that may change the desired rail pressure in response to changes in air system pressures, temperatures, and after treatment of gases. Monitoring for low pressure events and high pressure events may be of interest to a user during transient conditions so that the user may verify that the engine is operating within acceptable parameters.

U.S. Pat. No. 7,945,372, (“the '372 patent”), discloses a fuel system having a fuel rail containing pressured fuel coupled to a plurality of injectors. Control logic of the '372 patent determines whether the rail pressure is above a rail pressure threshold. In conjunction with other parameters, when the rail pressure exceeds the rail pressure threshold, the control logic of the '372 patent determines which injector of the plurality of injectors should be tested. Monitoring rail pressure for high pressure events that exceed a threshold may be helpful when attempting to determine the health of the fuel system. However, low pressure events may also be significant. Therefore, only monitoring for high pressure events, as well as reliance on a rail pressure threshold, may increase the difficulty of identifying and diagnosing irregularities, diminished performance, or relatively minor issues in a fuel system.

The methods and systems of the present disclosure may solve one or more of the problems set forth above and/or other problems in the art. The scope of the protection provided by the present disclosure, however, is defined by the attached claims, and not by the ability to solve any specific problem.

### SUMMARY

Each of the aspects disclosed herein may include one or more features described in connection with any of the other disclosed aspects.

Aspects of the present disclosure include a system for monitoring fuel rail pressure comprising an internal combustion engine, a plurality of fuel injectors configured to inject fuel into the internal combustion engine, a fuel rail configured to provide the fuel to the plurality of fuel injectors, a rail pressure sensor configured to detect a pressure of the fuel within the fuel rail, and a controller. The controller being configured to (i) determine a rail pressure based on a signal from the rail pressure sensor, (ii) determine at least one pressure threshold; (iii) calculate a pressure error between the rail pressure and the at least one pressure threshold, and (iv) determine a high pressure condition based on the pressure error.

Aspects of the present disclosure may be directed to a system for monitoring rail pressure comprising an internal combustion engine, a plurality of fuel injectors configured to inject fuel into the internal combustion engine, a fuel rail configured to provide the fuel to the plurality of fuel injectors, a rail pressure sensor configured to detect a pressure of the fuel within the fuel rail, and a controller. Wherein the controller is configured to (i) determined a desired rail pressure; (ii) determine a rail pressure error based on a rail pressure measured with the rail pressure sensor and the desired rail pressure, (iii) calculate a high rail pressure moving threshold and a low rail pressure moving threshold, (iv) calculate a difference between the rail pressure and one of the low rail pressure moving threshold and the high rail pressure moving threshold, and (v) monitor the difference between the rail pressure and one of the low rail pressure moving threshold and the high rail pressure moving threshold.

Aspects of the present disclosure may be directed to a method for monitoring rail pressure. The method comprising receiving, from a pressure sensor, a rail pressure. The method further comprising determining a desired rail pressure and calculating a rail pressure error based on the rail pressure from the rail pressure sensor and the desired rail pressure. The method comprises calculating a high rail pressure moving threshold and a low rail pressure moving threshold. The method further comprises incrementing a high rail pressure numerical value when the difference of the rail pressure and the high rail pressure moving threshold is a positive value and incrementing a low rail pressure numerical value when the difference of the rail pressure and the low rail pressure moving threshold is a negative value.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram of a fuel delivery monitoring system, according to aspects of the disclosure.

FIG. 2 is a block diagram of a controller of the fuel delivery monitoring system of FIG. 1.

FIG. 3 is a block diagram illustrating an exemplary logic map of the controller for calculating a desired filtered rail pressure.

FIG. 4 is a flowchart illustrating an exemplary method for fuel delivery monitoring.

FIG. 5A is a chart illustrating low rail pressure parameter values of the fuel delivery monitoring system pump when the fuel delivery monitoring system is in a pass state.

FIG. 5B is a chart illustrating low rail pressure parameter values of the fuel delivery monitoring system pump when the fuel delivery monitoring system is in a trip state.

FIG. 6A is a chart illustrating high rail pressure parameter values of the fuel delivery monitoring system pump when the fuel delivery monitoring system is in a pass state.

FIG. 6B is a chart illustrating high rail pressure parameter values of the fuel delivery monitoring system pump when the fuel delivery monitoring system is in a trip state.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value. As used herein, the phrase “based on” encompasses the phrases “based in part on” and “based entirely on.”

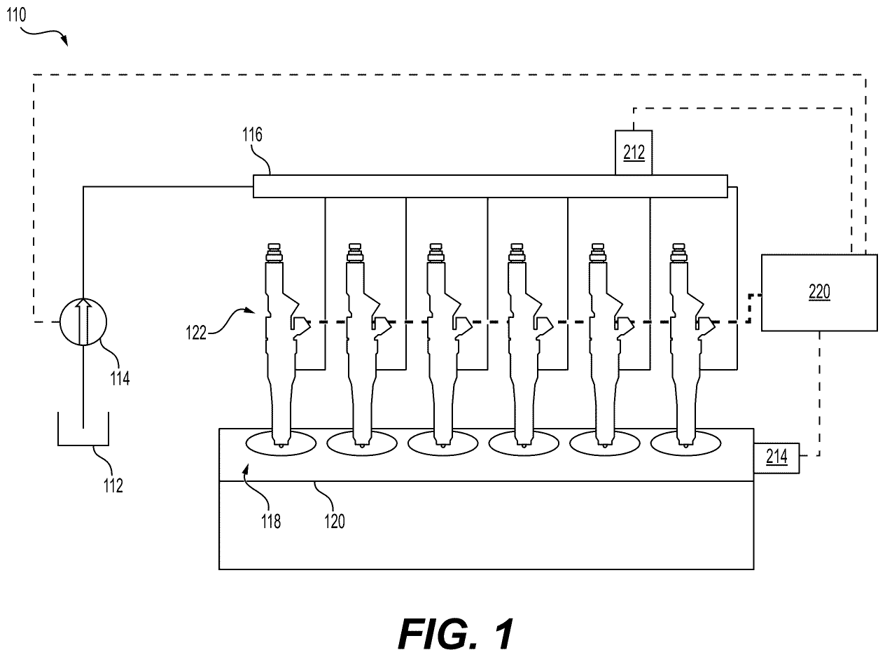

FIG. 1 is a partially-schematic diagram illustrating an internal combustion engine (e.g., for an industrial machine) and a fuel delivery monitoring system 110. Fuel delivery monitoring system 110 may include components for determining a quantity of fuel injected by a fuel injector 122. In particular, fuel monitoring system 110 may include an internal combustion engine 120, a fuel system for delivering fuel to internal combustion engine 120, and an electronic control module (ECM) 220, also referred to herein as a controller.

Internal combustion engine 120 may include a plurality of cylinders 118, six cylinders 118 being shown in FIG. 1. Internal combustion engine 120 may have any suitable number of cylinders 118, such as two, three, four, six, eight, ten, twelve, twenty, or more cylinders 118. Cylinders 118 may be arranged in a straight configuration, a V configuration, or another type of configuration known in the art. Internal combustion engine 120 may be configured for combustion of a single fuel, such as diesel fuel. In some configurations, internal combustion engine 120 may be configured for combustion of two fuels, such as diesel fuel and a gaseous fuel. In engines 120 configured for combustion of two fuels, one or both fuels may be supplied with a fuel rail.

Fuel injectors 122 of the fuel delivery system for internal combustion engine 120 may be configured for direct fuel injection (as shown) or port fuel injection. Fuel injectors 122 may be common rail injectors, such as hydraulically-actuated electronically-controlled injectors. Each fuel injector 122 may be in communication with ECM 220, such that injectors 122 inject fuel in response to signals generated with ECM 220. In at least some configurations, fuel injectors 122 may be configured to injection of a liquid fuel, such as diesel fuel. Fuel injectors 122 may be configured for injection of a gaseous fuel, instead of or in addition to injection of a liquid fuel.

The fuel delivery system for engine 120 may supply pressurized fuel to each injector 122. The fuel delivery system may include a fuel source 112 (e.g., a fuel tank, sump, etc.), a fuel pump 114, and a common fuel rail 116. The fuel delivery system may also include known components such as fuel filters, pressure regulation valves, etc.

A sensor system may provide feedback to ECM 220 to allow ECM 220 to control fuel pump 114 and injectors 122. In the example shown in FIG. 1, the sensor system includes a common rail pressure sensor 212 configured to measure a pressure of fuel within common fuel rail 116 and output a pressure signal and an engine speed sensor 214 configured to measure a speed of engine 120 and output an engine speed signal. Engine speed sensor 214 may be configured to detect a position of a crankshaft of internal combustion engine 120, for example.

ECM 220 may be configured to receive signals from each of the sensors of the sensor system, including common rail pressure sensor 212 and engine speed sensor 214. In some configurations, ECM 220 is located on an industrial machine and is configured to monitor and control fuel injection of that machine as well as monitor the health of one or multiple components of the fuel supply system. ECM 220 may be in communication with one or more additional ECMs or other controllers for the industrial machine.

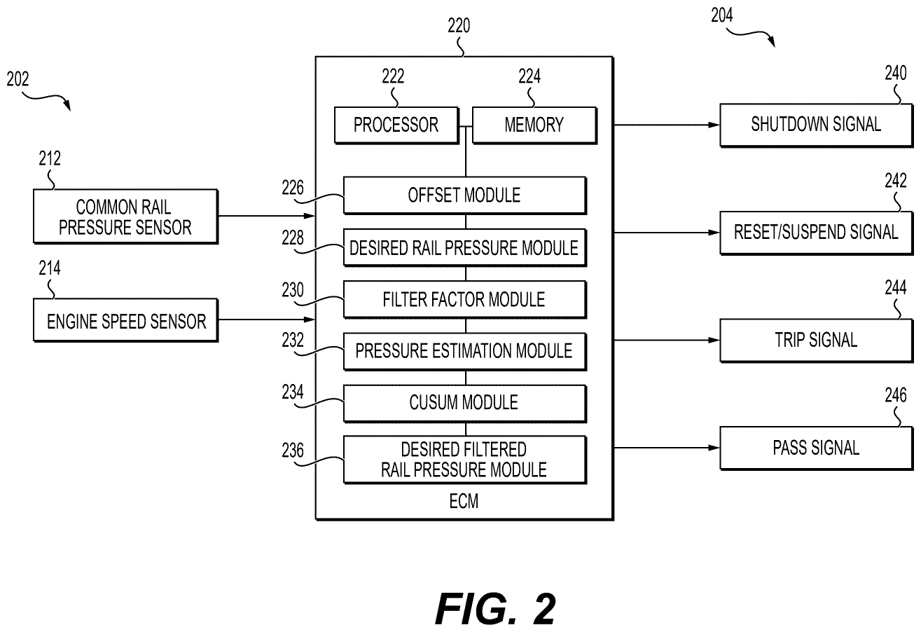

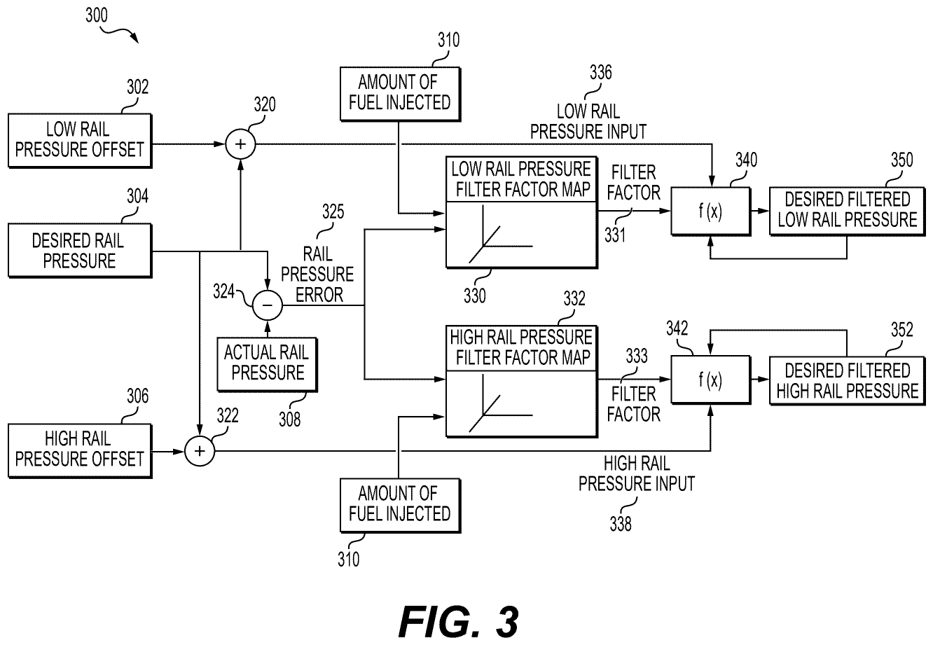

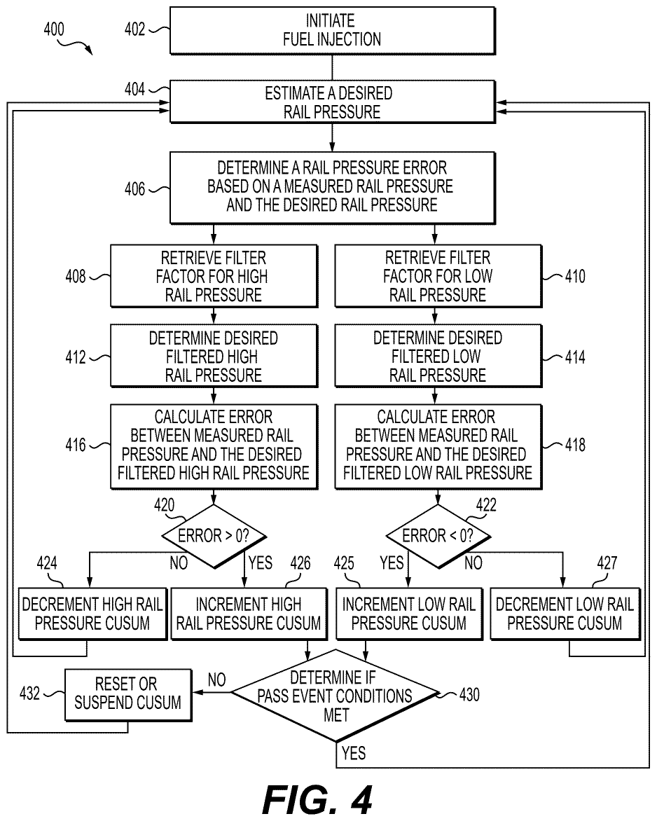

In particular, ECM 220 may encompass a single control module, or controller. As used herein, a “controller” encompasses both single controllers or control modules, or a plurality of controllers or control modules. ECM 220 may embody a single processor 222 (FIG. 2) or multiple processors 222 that receive inputs such as signals from common rail pressure sensor 212 and engine speed sensor 214. ECM 220 may include a memory 224 (FIG. 2), a secondary storage device, a processor 222 such as a central processing unit, or any other device for accomplishing a task consistent with the present disclosure, as described below. The memory 224 associated with ECM 220 may store data and software to allow ECM 220 to perform its functions, including the functions described below with respect to method block diagram 300 and method 400 of FIGS. 3 and 4 below, respectively. Numerous commercially available microprocessors can be configured to perform the functions of ECM 220. Various other known circuits may be associated with ECM 220, including current monitoring circuitry, signal-conditioning circuitry, communication circuitry, and other appropriate circuitry.

FIG. 2 is a block diagram illustrating an exemplary configuration of ECM 220. ECM 220 may be configured to continuously or periodically monitor monitoring system 110 during operation for low rail pressure events and take appropriate corrective actions when a pressure value is below a predetermined low rail pressure threshold a predetermined number of times and/or over a predetermined period of time. Additionally, ECM 220 may continuously or periodically monitor monitoring system 110 during operation for high rail pressure events and take appropriate corrective actions when a pressure value exceeds a predetermined high pressure threshold a predetermined number of times and/or over a predetermined period of time. ECM 220 may simultaneously perform monitor and update the low rail pressure threshold and the high rail pressure threshold, as described below.

As shown in FIG. 2 and described above, ECM 220 may include one or more processors 222 and memory 224. The one or more processors 222 and memory 224 may be operable to implement an offset module 226, a desired rail pressure module 228, a filter factor module 230, a pressure estimation module 232, a cusum module 234, and/or a desired filtered rail pressure module 236. One or more of the modules of ECM 220 (e.g., offset module 226, desired rail pressure module 228, filter factor module 230, pressure estimation module 232, cusum module 234, and desired filtered rail pressure module 236) may receive inputs 202 and generate outputs 204 to respond to high rail pressure events and low rail pressure events of system 110.

FIG. 3 depicts a logic map 300 for calculating a desired filtered high rail pressure 352 (DFHRP) and a desired filtered low rail pressure 350 (DFLRP). Herein, DFHRP 352 may also be referred to as the HRP moving threshold (e.g., HRP dynamic threshold) or a worst acceptable high rail pressure error. Similarly, herein, DFLRP 350 may be referred to as the LRP moving threshold (e.g., LRP dynamic threshold) or a worst acceptable low rail pressure error. Together, DFLRP 350 and DFHRP 352 may function as an acceptable operating range for the measured rail pressure with DFHRP 352 functioning as an upper bound or threshold and DFLRP 350 functioning as a lower bound or threshold. ECM 220 may be configured to record the measured rail pressure, variance (e.g. positive or negative variance) of the measured rail pressure from each of DFLRP 350 and DFHRP 352, and the magnitude of the variances. ECM 220 may be configured to take corrective action(s) (e.g., via outputs 204 discussed below) based on the quantity of variances, the polarity (e.g., positive or negative) of the variances, and the magnitude of the variances over a period of time. As the range between DFLRP 350 and DFHRP 352 may represent acceptable operating values of the measured rail pressure, ECM 220 may be configured to simultaneously monitor and compare the measured rail pressure with respect to DFHRP 352 and DFLRP 350 (e.g., recording variances from DFHRP 352 and variances from DFLRP 350) and simultaneously update/adjust DFHRP 352 and DRLRP based on conditions experienced by and/or parameter values of system 110.

DFHRP 352, or HRP moving threshold, is a calculated upper limit for the measured rail pressure that may be adjusted during operation of the engine based on one or more parameter values of system 110. DFHRP 352 may be adjusted continuously or periodically by ECM 220 using logic map 300 (and/or as described below with respect to method 400). For example, during periods of high load on system 110, ECM 220 may calculate a greater value for DFHRP 352 compared to periods of low load on system 110. The measured rail pressure may exceed DFHRP 352 one or more times during operation, such as when transient conditions are being experienced by system 110. Instead of ECM 220 taking corrective action in response to any one positive deviation above DFHRP 352, ECM 220 may be configured to take correction action based on the quantity and/or magnitudes of the positive variances over a period of time weighed against the quantity and/or magnitude of negative variances (e.g., variances within the acceptable range). ECM 220 may be further configured to attribute greater weight to positive variances from DFHRP 352 as compared to negative variances from DFHRP 352 as negative variations may be within the acceptable range.

DFLRP 350, or LRP moving threshold, is a calculated lower limit for the measured rail pressure that may be adjusted during operation of the engine based on one or more parameter values of system 110. In an exemplary embodiment, during a period where system 110 is experiencing a high load, ECM 220 may calculate a greater value for DFLRP 350 as compared to periods of low load. DFLRP 350 may be adjusted continuously or periodically by ECM 220 using logic map 300 (and/or as described below with respect to method 400). The measured rail pressure may be below DFLRP 350 one or more times during operation, such as when transient conditions are being experienced by system 110. Instead of ECM 220 taking corrective action in response to any one negative deviation below DFLRP 350, ECM 220 may be configured to take correction action based on the quantity and/or magnitudes of the negative variances over a period of time weighed against the quantity and/or magnitudes of the positive variances (e.g., variances within the acceptable range). ECM 220 may be further configured to attribute greater weight to negative variances from DFLRP 350 as compared to positive variances from DFLRP 350 as positive variations may be within the acceptable range.

The components, inputs, and outputs of ECM 220 are further discussed below in view of FIG. 3. It should be understood that reference numbers in the 200s correspond to FIG. 2 and reference numbers in the 300s correspond to FIG. 3.

Inputs 202 (FIG. 2) may include an actual rail pressure 308 from common rail pressure sensor 212 and engine speed from engine speed sensor 214. ECM 220 may be configured to use the engine speed from engine speed sensor 214 to determine an amount of fuel injected 310. Inputs 202 may further include other information related to the operation of internal combustion engine 120 and/or other components for system 110. Additional inputs 202 may include, for example, signals from temperature sensors, flow sensors, airflow sensors, additional pressure sensors, and others. Inputs 202 may be received continuously or periodically while fuel monitoring system 110 is operating.

Offset module 226 of ECM 220 may be configured to receive and store a low rail pressure offset (e.g., low rail pressure offset 302) and a high rail pressure offset (e.g., high rail press offset 306). Offsets 302, 306 may facilitate a margin for phase lag, overshoot (e.g., actual rail pressure being greater than DFHRP 352), and undershoot (e.g., actual rail pressure being less than DFLRP 350). Low rail pressure offset 302 and high rail pressure offset 306 may each be a predetermined and/or pre-selected, by a user during and/or prior to operation, value. For example, prior to or during operation, a user may provide the low rail pressure offset 302 and high rail pressure offset 306. In some examples, offset 302, 306 may be steady-state worst acceptance error thresholds. For example, while system 110 is in a steady-state (e.g., as opposed to a transient state), if the steady-state low rail pressure error threshold is set as (e.g., by a user) or determined to be (e.g., by ECM 220) −10 MPa, then the low rail pressure offset 302 may be −10 MPa. Moreover, while system 110 is in steady-state, if the steady-state high rail pressure error threshold is set as or determined to be +10MPa, then the high rail pressure offset 306 may be +10MPa. Accordingly, high rail pressure offset 306 may be a positive value in MPa and low rail pressure offset 302 may be a negative value in MPa. Offset module 226 may be configured to adjust (e.g., increase or decreases) low rail pressure offset 302 and high rail pressure offset 306 based on one or more parameter values such as engine speed. For example, while system 110 is in a steady-state, ECM 220 may be configured to offsets 302, 306 because on the set as or determined steady-state low rail pressure threshold and steady-state high rail pressure threshold, respectively. Further, while offsets 302, 306 are described as numerical offsets herein, it should be understood that offsets 302, 306 may be a percentage offset (e.g., +/−10%) from a desired rail pressure discussed below.

According to some aspects of the present disclosure, low rail pressure offset 302 may include one or more low rail pressure offsets and be a summation of the one or more low rail pressure offsets. For example, the one or more low rail pressure offsets may include one or more secondary offsets that may be provided to ECM 220 by other modules of ECM 220 or other controllers of system 110 in communication with ECM 220 and, as discussed above, one or more of the one or more low rail pressure offsets may be provided by the user or ECM 220 (e.g., via offset module 226). Similarly, high rail pressure offset 306 may also include one or more high rail pressure offsets and be a summation of the one or more high rail pressure offsets. In exemplary embodiments, the one or more high rail pressure offsets may include one or more secondary offsets that may be provided to ECM 220 by other modules of ECM 220 or other controllers of system 110 in communication with ECM 220. As discussed above, one or more of the one or more high rail pressure offsets may be provided to ECM 220 by the user or ECM 220. The secondary offsets of the one or more low rail pressure offsets and the one or more high rail pressure offsets may be worst acceptable errors of other modules of ECM 220 or other controllers of system 110.

Desired rail pressure module 228 of ECM 220 may be configured calculate a desired rail pressure 304 of system 110. Desired rail pressure module 228 may include maps, lookup tables, etc., and/or a program or algorithm for calculating the desired rail pressure 304 of system 110 based on the desired amount of fuel injected by injectors 122 (e.g., provided to rail 116) and according to engine speed, desired output, load, etc. The program or algorithm may be configured to run a simulation, or output data according to a previous simulation, of a system modeled after system 110 with similar and/or identical parameter values. Desired rail pressure module 228 may continuously or periodically recalculate the desired rail pressure 304 of system 110 during operation as the amount of fuel injected by injectors 122 and/or the engine speed increases or decreases.

Pressure estimation module 232 may be configured to calculate a rail pressure error (e.g., rail pressure error 325) of system 110. Pressure estimation module 232 may be configured to receive the desired rail pressure 304 of system 110 from desired rail pressure module 228 and receive an actual rail pressure 308 from common rail pressure sensor 212. Pressure estimation module 232 may be further configured to calculate rail pressure error by taking the difference of the desired rail pressure, from module 228, subtracted from the actual rail pressure, from common rail pressure sensor 212. As shown in FIG. 3, rail pressure error 325 may be an output of difference node 324 which subtracts desired rail pressure 304 from actual rail pressure 308. It should be understood that the calculated rail pressure error may be a positive value or a negative value representing whether the actual pressure is above or below the desired pressure, respectively.

Filter factor module 230 may be configured to provide a low rail pressure filter factor (e.g., LFF 331) of system 110 and a high rail pressure filter factor (e.g., HFF 333) of system 110. The LFF 331 may be used in calculating the DFLRP 350 and the HFF 333 may be used in calculating the DFHRP 352. LFF 331 and HFF 333 may each be a filter coefficient for a low pass filter. In some examples, LFF 331 and HFF 333 may be a filter coefficient for a simple low pass filter. In some exemplary embodiments, LFF 331 and HFF 333 may be a filter coefficient for a complex low pass filter. For example, each of LFF 331 and HFF 333 filter coefficients for a low pass filter such that the filter factors are configured to not pass (attenuate) a signal greater a cutoff frequency and pass (amplify) a signal less than the cut off frequency. Filter factor module 230 may include an array of parameter values for the LFF 331 (e.g., a low rail pressure filter factor map 330) and an array of parameter values for the HFF 333 (e.g., a high rail pressure filter factor map 332). Filter factor module 230 may be configured to receive the amount of fuel injected 310 (e.g., the amount of fuel injected by injectors 122) and the rail pressure error from pressure estimation module 232 and, based on these parameter values, retrieve and provide LFF 331 and HFF 333 from the respective filter factor maps 330, 332. According to an alternative embodiment of the present disclosure, instead of retrieving LFF 331 and HFF 333 from respectively filter factor maps 330, 332, one or more of LFF 331 and HFF 333 may be a predetermined static value.

Desired filtered rail pressure module 236 may be configured to calculate a desired filtered high rail pressure of system 110 and a desired filtered low rail pressure of system 110. For example, for calculating the desired filtered high rail pressure (DFHRP 352) of system 110, desired filtered rail pressure module 236 may receive the high rail pressure filter factor (HFF 333) from high rail pressure filter factor map 332 via filter factor module 230, a previous or predetermined desired filtered high rail pressure (PDFHRP), and a summation of a high rail pressure offset (e.g., high rail pressure offset 306) from offset module 226 and the desired rail pressure from desired rail pressure module 228 (HI) (e.g., output by summation node 322 in FIG. 3). After receiving the aforementioned parameter values, the desired filtered rail pressure module 236 may perform a calculation utilizing the following equation (1.1):

$$DFHRP = ( HI ) ( HFF ) + ( PDFHRP ) ( 1 - HFF ) \qquad ( 1.1 )$$

For example, after receiving the aforementioned parameter values, equation node 342, using equation 1.1 or corresponding technique, may calculate DFHRP 352. A portion of equation 1.1, (PDFHRP)(1−HFF), may function to tune DFHRP 352 to match the actual rail pressure (e.g., actual rail pressure 308). If DFHRP 352 is tuned to actual rail pressure 308 or approximately to actual rail pressure 308 with the aforementioned portion of equation 1.1, or by other means known to those skilled in the art, high rail pressure offset 306 may include one or more secondary offsets.

As another example, for calculating the desired filtered low rail pressure of system 110 (DFLRP 350), filtered desired rail pressure module 236 may receive the low rail pressure filter factor (LFF 331) from low rail pressure filter factor map 330 via filter factor module 230, a previous or predetermined desired filtered low rail pressure (PDFLRP), and a summation of a low rail pressure offset from offset module 226 and the desired rail pressure from desired rail pressure module 228 (LI) (e.g., output by summation node 320). After receiving the aforementioned parameter values, the desired filtered rail pressure module 236 may perform a calculation utilizing the following equation (1.2):

$$DFLRP = ( LI ) ( LFF ) + ( PDFLRP ) ( 1 - LFF ) \qquad ( 1.2 )$$

A portion of equation 1.2, (PDFLRP)(1−LFF), may function to tune DFLRP 350 to match the actual rail pressure 308. If DFLRP 350 is tuned to actual rail pressure 308 or approximately to actual rail pressure 308 with the aforementioned portion of equation 1.2, or by other means known to those skilled in the art, low rail pressure offset 302 may include one or more secondary offsets.

As another example, after receiving the aforementioned parameter values, equation node 340, using equation 1.2 or corresponding technique, may calculate DFLRP 350. The desired filtered rail pressure module 236 may be configured to continuously or periodically recalculate DFHRP 352 and DFLRP 350 based on current (e.g., instantaneous or real-time) parameter values of system 110. Subsequent recalculations of DFHRP 352 and DFLRP 350 may utilize one or more previous calculations of DFHRP 352 and DFLRP 350 as PDFHRP and PDFLRP, respectively.

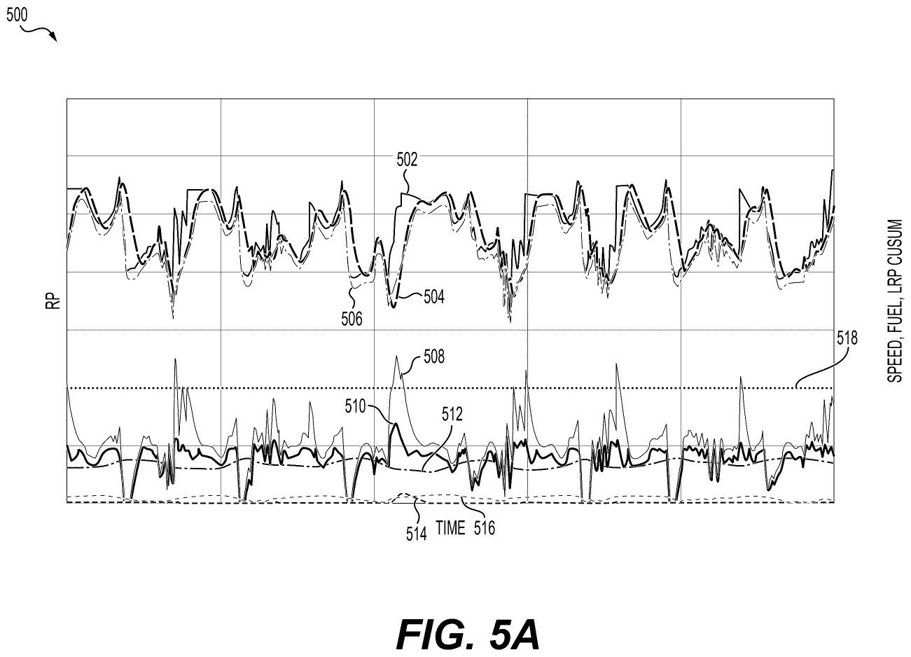

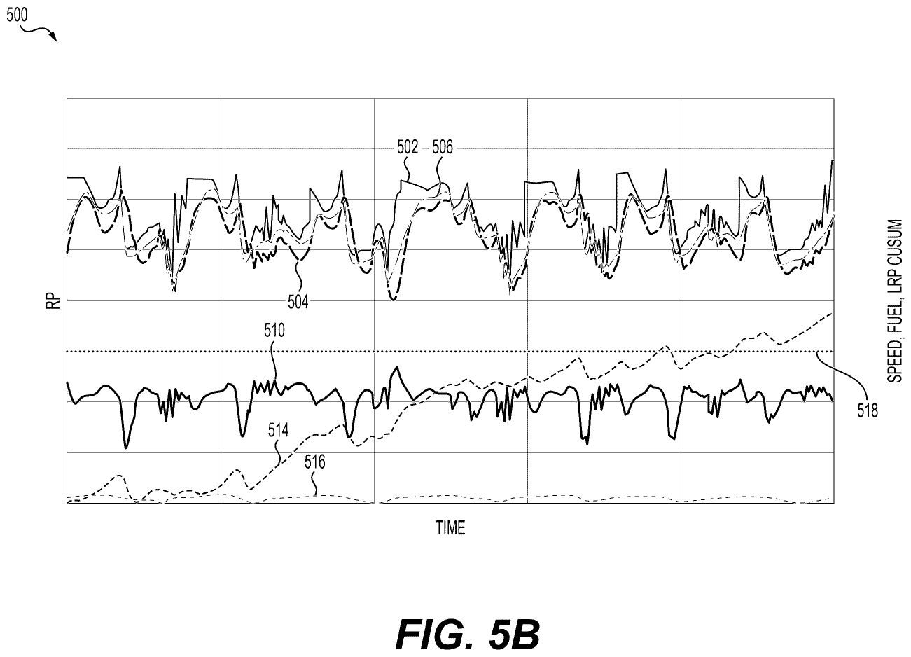

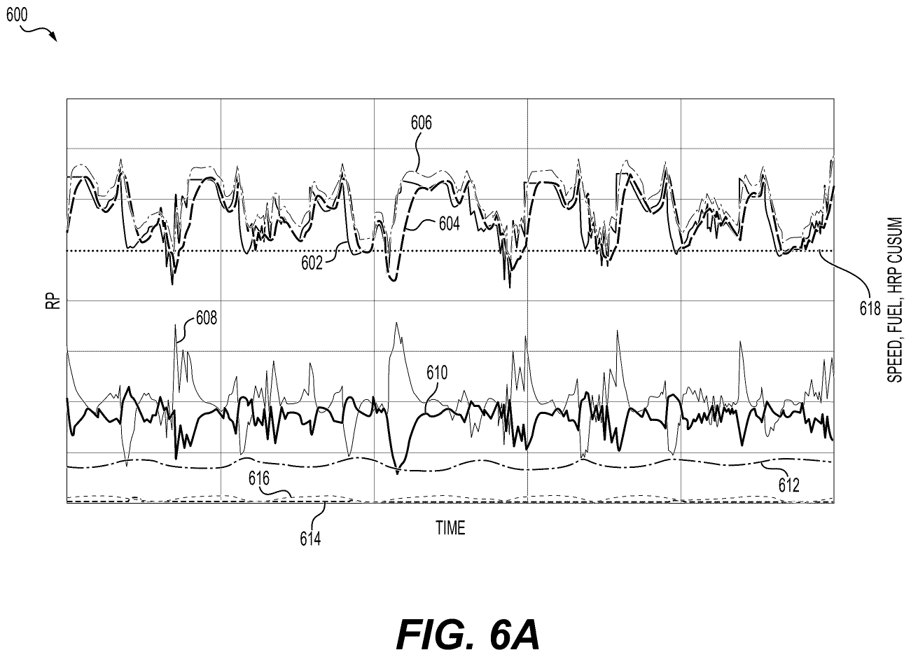

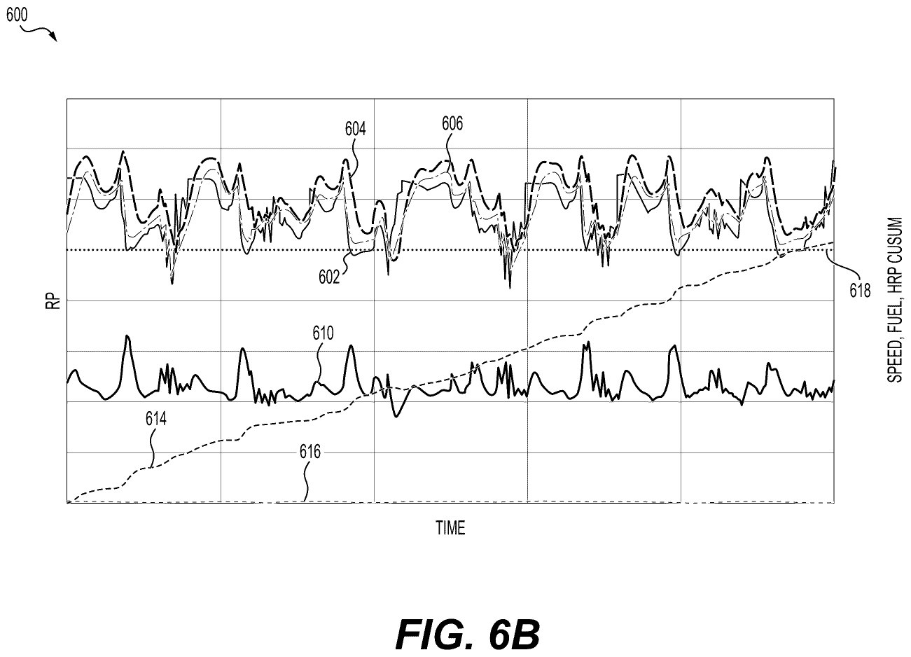

Cusum module 234 may be configured to calculate, update, and monitor a low rail pressure cusum 514 (LRPCusum) and a high rail pressure cusum 614 (HRPCusum). Examples of LRPCusum 514 and HRPCusum 614 values are illustrated in FIGS. 5A-6B. A cumulative sum (cusum) is a sequential analysis tool in the form of a control chart, an array of data, or a numerical value (e.g., sum of variances) used to monitor small shifts in a process mean using the cumulative sum of variances from a target. Cusum module 234 may monitor a numerical representations of LRPCusum 514 and HRPCusum 614 and may compare cusums 514, 614 to predetermined threshold as discussed below. Cusum module 234 may be configured to receive the actual rail pressure from common rail pressure sensor 212, and receive DFLRP 350 and DFHRP 352 from desired filtered rail pressure module 236.

For example, for calculating and updating HRPCusum 614, cusum module 234 may calculate the difference of the actual rail pressure of common rail pressure sensor 212 subtracted by DFHRP 352. HRPCusum 614 may be configured to increment when the difference between the actual rail pressure and DFHRP 352 is a positive value (e.g., greater than zero). If desired, HRPCusum 614 may decrement when the difference between actual rail pressure and DFHRP 352 is a negative value. If the actual rail pressure is equal to DFHRP 352, then HRPCusum 614 may be configured to neither increment nor decrement. HRPCusum 614 may be further configured to increment more quickly than it decrements. For example, where DFHRP 352 is 100 MPa and the error between the actual rail pressure and DFHRP is about zero, HRPCusum 614 may be configured to decrement at a predetermined rate. The predetermined rate of decrementing may be greatest when the error between the actual rail pressure and DFHRP is about zero. Where DFHRP 352 is 100 MPa and the error is 100 MPa, HRPCusum 614 may be configured increment twice as fast as HRPCusum 614 decrements when the error is about zero. In other examples, where DFHRP 352 is 100 MPa and the error is 200 MPa, HRPCusum 614 may be configured to increment three times as fast as HRPCusum 614 decrements when the error is about zero.

As another example, for calculating and updating LRPCusum 514, cusum module 234 may calculate the difference of the actual rail pressure from common rail pressure sensor 212 subtracted by DFLRP 350. LRPCusum 514 may be configured to increment when the difference between the actual rail pressure and DFLRP 350 is a negative value (e.g., less than zero) and decrement when the difference is a positive value. Similarly to HRPCusum 614, LRPCusum 514 may be further configured to increment more quickly than it decrements. If the actual rail pressure is equal to DFLRP 350, the LRPCusum 514 may be configured to neither increment nor decrement. In some examples, where DFLRP 350 is 10 MPa and the error between the actual rail pressure and DFLRP 350 is about zero, LRPCusum 514 may be configured to decrement at a predetermined rate. The predetermined rate of decrementing may be greatest when the error between the actual rail pressure and DFLRP 350 is about zero. Where DFLRP 350 is 10 MPa and the error is 10 MPa, LRPCusum 514 may be configured increment twice times as fast as LRPCusum 514 decrements when the error is about zero. In other examples, where DFLRP 350 is 10 MPa and the error is 40 MPa, LRPCusum 514 may be configured to increment three times as fast as LRPCusum 514 decrements when the error is about zero.

Cusum module 234 may include a low rail pressure trip threshold 518 (LRP trip threshold) and a high rail pressure trip threshold 618 (HRP trip threshold). Tripping either trip threshold 518, 618 may be indicative that one or more fuel injectors 122 are experiencing a low health condition. ECM 220 may be configured to provide one or more outputs 204 when LRPCusum 514 increments to and meets LRP trip threshold 518 and/or when HRPCusum 614 increments to and meets HRP trip threshold 618.

Outputs 204 may be in the form of data, signals etc. Outputs 204 may include a shutdown signal 240, a reset/suspend signal 242, a trip signal 244, and a pass signal 246. ECM 220 may be configured to issue pass signal 246 when neither LRPCusum 514 exceeds LRP trip threshold 518 nor HRPCusum 614 exceeds HRP trip threshold 618. Pass signal 246 may be indicative that system 110 is not currently in a trip state, e.g., experiencing a sufficient amount of high rail pressure events or low rail pressure events to trip at least one of trip thresholds 518, 618. ECM 220 may be configured to continuously or periodically output pass signal 246 except while ECM 220 is outputting trip signal 244.

ECM 220 may be configured to issue trip signal 244 when LRPCusum 514 exceeds LRP trip threshold 518 and/or when HRPCusum 614 exceeds HRP trip threshold 618. Trip signal 244 may be indicative that system 110 is in a trip state, e.g., experiencing a sufficient amount of high rail pressure events or low rail pressure events to trip at least one of trip thresholds 518, 618. Trip signal 244 may trigger an alert notification to notify a user. For example, ECM 220 may be configured to issue an alert to a connected display within an interior of a machine including system 110. ECM 220 may be configured to cease outputting pass signal 246 while outputting trip signal 244.

ECM 220 may be configured to issue shutdown signal 240 when trip signal 244 is being output by ECM 220. For example, if system 110 is in a trip state for a predetermined amount of time, or immediately upon detecting a trip state, ECM 220 may issue shutdown signal 240. Shutdown signal 240 may be configured to shutdown system 110 and/or cause one or more of injectors 122 to stop injecting fuel. ECM 220 may issue shutdown signal 240 to prevent system 110 from operating at too high (e.g., actual rail pressure is greater than DFHRP 352) or too low of a rail pressure (e.g., actual rail pressure is less than DFLRP 350). Shutdown signal 240 may be configured to prevent damage to system 110 due to the actual rail pressure being too high or too low. According to one or more embodiments of the present disclosure, instead of shutting down system 110, shutdown signal 240 may slow system 110 to allow HRPCusum 614 and LRPCusum 514 to naturally decrement to zero.

ECM 220 may be further configured to issue reset/suspend signal 242 when LRPCusum 514 exceeds LRP trip threshold 518 and/or when HRPCusum 614 exceeds HRP trip threshold 618, upon startup of system 110, or while system 110 is experiencing a transient condition. According to some aspects of the present disclosure, ECM 220 may be configured to issue reset/suspend signal 242 when ECM 220 is outputting trip signal 244 instead of pass signal 246. Reset/suspend signal 242 may reset HRPCusum 614 and/or LRPCusum 514 to zero or suspend HRPCusum 614 and/or LRPCusum 514 until it decrements to zero. ECM 220, via reset/suspend signal 242, may reset one or more of HRPCusum 614 and LRPCusum 514 by setting the values of the cusum to zero when the one or more of HRPCusum 614 and LRPCusum 614 may be unreliable such as when a component (such as common rail pressure sensor 212) is faulty. After resetting one or more of HRPCusum 614 and LRPCusum 514 to zero, ECM 220 may be configured to maintain the reset cusum at zero to prevent trip signal 244 from being issued. It should be understood that an unreliable component may cause the respective cusum 514, 614 to constantly increment beyond respective threshold 518, 618, as such it may be desirable to maintain the respective cusum at zero until system 110 can be inspected for faults. Alternatively, ECM 220, via reset/suspend signal 242, may suspend (e.g., preventing incrementing or decrementing) one or more of HRPCusum 614 and LRPCusum 514 when the one or more of HRPCusum 614 and LRPCusum 514 may be unreliable such as when system 110 is experiencing a transient condition. ECM 220 may be configured to determine when system 110 is experiencing a transient condition (e.g., such as an increase in load or vehicle speed). In some instances, ECM 220 may suspend one or more of LRPCusum 514 and HRPCusum 614 from incrementing but allow decrementing so that the suspended cusum may naturally decrement to zero after sufficient time. After outputting trip signal 244, it may be necessary to reset or suspend HRPCusum 614 and/or LRPCusum 514 so that ECM 220 outputs pass signal 246. For example, without resetting or suspending one or more of LRPCusum 514 and HRPCusum 614, after ECM 220, via cusum module 234, re-initiates (e.g., begins incrementing and/or decrementing) respective cusum 514, 614, it may already be above respective threshold 518, 618 and cause ECM 220 to output trip signal 244. According to some aspects of the present disclosure, ECM 220 may be configured to suspend HRPCusum 614 when an amount of fuel injected by injectors 122 is zero or approximately zero.

FIG. 4 depicts an exemplary flowchart of a method for regulating rail pressure, a method 400. Method 400 may be performed by ECM 220, or another device of the industrial machine. For example, method 400 may be performed by ECM 220 continuously or periodically during operation. Method 400 may include an initial step of providing the low rail pressure offset (e.g., low rail pressure offset 302) and the high rail pressure offset (e.g., high rail pressure offset 306). In exemplary embodiments, the user may provide the low rail pressure offset and the high rail pressure offset to offset module 226 of ECM 220. Alternatively, or in addition to the user providing the offsets, the offsets may be provided to ECM 220 during manufacture of system 110.

Method 400 comprises a step 402 of initiating fuel injection. Fuel injection may be initiated via a control signal to system 110 or ECM 220, or turning ON system 110 via an ignition of the industrial machine. Step 402 may further include a step of receiving a measured (actual) rail pressure (e.g., actual rail pressure 308). For example, ECM 220 may be configured to receive the measured rail pressure from common rail pressure sensor 212.

Method 400 comprises a step 404 of calculating a desired rail pressure (e.g., desired rail pressure 304). For example, ECM 220 may calculate the desired rail pressure via desired rail pressure module 228. Step 404 may include providing a desired output of fuel provided to rail 116, an amount of fuel injected by injectors 122 (e.g., amount of fuel injected 310), an engine speed, a load on a machine including system 110, etc. For example, the amount of fuel injected may be calculated with or retrieved by ECM 220. Engine speed may be provided to ECM 220 via engine speed sensor 214. Step 404 may further include running a simulation of a model of system 110 with provided parameter values. Engine speed may be provided in rotations per minute (rpm) and the amount of fuel injected by injectors 122 may be provided in cubic millimeters (mm³).

Method 400 may further comprise a step 406 of calculating a rail pressure error (e.g., rail pressure error 325 calculated at difference node 324) based on a measured rail pressure (e.g., actual rail pressure 308) and the desired rail pressure (e.g., desired rail pressure 304) calculated in step 404. As discussed, the measured rail pressure may be provided by common rail pressure sensor 212. ECM 220 may be configured to estimate the rail pressure error via pressure estimation module 232. The rail pressure error may be the desired rail pressure subtracted from the measured rail pressure. For example, if desired rail pressure is 220 megapascals (MPa) and the measured rail pressure is 200 MPa, pressure estimation module 232 would calculate an error of −20 MPa. As another example, if desired rail pressure is 220 MPa and the measured rail pressure is 240 MPa, pressure estimation module 232 would calculate an error of +20 MPa.

After step 406, proceeding steps are bifurcated or branched with separate steps for comparing the measured rail pressure to the HRP moving threshold (e.g., DFHRP 352) and the LRP moving threshold (e.g., DFLRP 350) and adjusting (e.g., incrementing, decrementing, or maintaining) the HRPCusum 614 and LRPCusum 514, respectively. While illustrated as branched steps, as understood, each of these steps of method 400 may be performed simultaneously, or sequentially (e.g., one branch is performed following performance of the other branch in a repeated manner).

Method 400 further comprises a step 408 of retrieving a high rail pressure filter factor (HFF) (e.g., HFF 333 from high rail pressure filter factor map 332) for the HRP moving threshold (e.g., DFHRP 352). Step 408 may further include providing and/or retrieving the rail pressure error calculated in step 406 (e.g., by pressure estimation module 232) and the amount of fuel injected by injectors 122 (e.g., amount of fuel injected 310). ECM 220 may retrieve the HFF from filter factor module 230 based on the amount of fuel injected by injectors 122 and the calculated rail pressure error (e.g., rail pressure error 325) of step 406. Accordingly, filter factor module 230 may be configured to return a greater HFF when the rail pressure error is a greater than or equal to zero and return a lesser HFF when the rail pressure error is less than zero. In other words, the HFF retrieved by filter factor module 230, relative to when the rail pressure error is less than zero, may be configured to amplify signals containing a rail pressure error that is greater than or equal to zero and attenuate signals containing a rail pressure error that is lesser than zero. Filter factor module 230 may be further configured to retrieve a larger HFF that closer the calculated rail pressure error is to zero. For example, when the rail pressure error is 6 MPa, the filter factor module 230 may retrieve a greater HFF than when rail pressure error is 50 MPa.

Method 400 comprises a step 412 of determining a desired filtered high rail pressure (e.g., DFHRP 352). Step 412 may further include retrieving the high rail pressure offset (e.g., high rail pressure offset 306). For example, ECM 220 may be configured to retrieve the high rail pressure offset from offset module 226. Step 412 may include calculating an offset desired high rail pressure (e.g., high rail pressure input 338) by calculating the summation of the desired rail pressure and the high rail pressure offset. Using the retrieved HFF of step 408, the offset desired high rail pressure (e.g., variable HI of equation 1.1), a predetermined or previous DFHRP (e.g., variable PDFHRP), ECM 220 may calculate the DFHRP (e.g., at equation node 342) using the equation 1.1.

Method 400 further comprises a step 416 of calculating an error between the DFHRP (e.g., DFHRP 352) and the measured rail pressure (e.g., actual rail pressure 308). For example, ECM 220 may calculate the error between the DFHRP of step 412 and the measured rail pressure of step 406 by subtracting DFHRP from measured rail pressure. An exemplary calculation may include a measured rail pressure of 220 MPa and the DFHRP of 240 MPa would result in an error of −20 MPa. Another exemplary calculation may include a measure rail pressure of 260 MPa and the DFHRP of 240 MPa would result in an error of +20 MPa.

Method 400 further comprises steps 420, 424, and 426, where step 420 includes determining if the error between DFHRP (e.g., DFHRP 352) and the measure rail pressure (e.g., actual rail pressure 308) of step 416 is greater than zero. ECM 220 may include a tolerance for values greater than zero. If the error of step 416 is less than zero, method 400 performs step 424 of decrementing the high rail pressure cusum (e.g., HRPCusum 614 of cusum module 234), or holding HRPCusum 614 at a constant value (such as zero), and returning to step 404. If the error of step 416 is greater than zero, method 400 performs step 426 of incrementing the high rail pressure cusum. In an exemplary embodiment, if the error of step 416 is greater than zero and outside of the tolerance, method 400 performs the step 426 of incrementing the high rail pressure cusum, but if the error is greater than zero and inside of the tolerance, method 400 may include a step of maintaining or decrementing the high rail pressure cusum.

After step 426, method 400 further includes step 430 of determining if system 110 is in a pass state in which a pass event condition is met. System 110 is in the pass state when the high rail pressure cusum is less than the HRP trip threshold 618. For example, as shown in FIG. 6B, at fifteen seconds, HRPCusum 614 is approximately 60% of the HRP trip threshold 618, and therefore ECM 220 determines the pass event condition to be met and that system 110 is in the pass state. Accordingly, ECM 220 may issue pass signal 246 while system 110 is in the pass state. Contrastingly, at twenty seconds, HRPCusum 614 is greater than the HRP trip threshold 618, and therefore ECM 220 determines the pass event condition is not met and that system 110 to be in a trip state. Accordingly, ECM 220 may issue trip signal 244 while system 110 is in the trip. If the pass event condition of step 430 is met, method 400 may further include returning to step 404. If the pass event condition is not met, method 400 may further include a step 432 of resetting or suspending the cusum (e.g., LRPCusum 514 and/or HRPCusum 614). For example, when HRPCusum 614 exceeds trip threshold 618, ECM 220 may issue reset/suspend signal 242 to reset or suspend at least one of cusums 514, 614.

Still referring to FIG. 4, method 400 further comprises a step 410 of retrieving a low rail pressure filter factor (LFF) (e.g., LFF 331 from low rail pressure filter factor map 330) for the LRP moving threshold (e.g., DFLRP 350). Step 410 may further include providing the rail pressure error calculated in step 406 (e.g., by pressure estimation module 232) and the amount of fuel injected by injectors 122 (e.g., amount of fuel injected 310). ECM 220 may retrieve the LFF from filter factor module 230 based on the amount of fuel injected by injectors 122 and the calculated rail pressure error (e.g., rail pressure error 325 calculated at difference node 324) of step 406. Filter factor module 230 may be configured to return a greater LFF when the rail pressure error is a less than zero and may return a lesser LFF when the rail pressure error is greater than zero. In other words, filter factor module 230, relative to when the rail pressure error is greater than zero, may be configured to amplify signals containing a rail pressure error that is less than to zero and attenuate signals containing a rail pressure error that is greater than zero.

Method 400 comprises a step 414 of determining a desired filtered low rail pressure (e.g. DFLRP 350). Step 414 may further include retrieving the low rail pressure offset (e.g., low rail pressure offset 302). For example, ECM 220 may be configured to retrieve the low rail pressure offset from offset module 226. Step 414 may include calculating an offset desired low rail pressure (e.g., low rail pressure input 336) by calculating the summation of the desired rail pressure (e.g., desired rail pressure 304) and the low rail pressure offset. Using the retrieved LFF of step 410, the offset desired low rail pressure (e.g., variable LI of equation 1.2), a predetermined or previous DFLRP (e.g., variable PDFLRP), ECM 220 may calculate the DFLRP (e.g., equation node 340) using the equation 1.2.

Method 400 further comprises a step 418 of calculating an error between the DFLRP (e.g., DFLRP 350) and the measured rail pressure (e.g., actual rail pressure 308). For example, ECM 220 may calculate the error between the DFLRP of step 414 and the measured rail pressure of step 406 by subtracting the DFLRP from the measured rail pressure. An exemplary calculation may include a measured rail pressure of 220 MPa and the DFLRP of 240 MPa would result in an error of −20 MPa. Another exemplary calculation may include a measure rail pressure of 260 MPa and the DFHRP of 240 MPa would result in an error of +20 MPa.

Method 400 further comprises steps 422, 425, 427, where step 422 includes determining if the error between DFLRP (e.g., DFLRP 350) and the measured rail pressure (e.g. actual rail pressure 308) of step 418 is less than zero. ECM 220 may include a tolerance for values less than zero. If the error of step 418 is greater than zero, method 400 includes step 427 of decrementing the low rail pressure cusum (e.g., LRPCusum 514 of cusum module 234) and returning to step 404. If the error of step 418 is less than zero, method 400 includes step 425 of incrementing the low rail pressure cusum 514, or holding LRPCusum 514 at a constant value. In an exemplary embodiment, if the error of step 418 is less than zero and outside of the tolerance, method 400 performs the step 427 of incrementing the low rail pressure cusum, but if the error is less than zero and inside of the tolerance, method 400 may include a step of maintaining or decrementing the low rail pressure cusum.

After step 425, method 400 further includes step 430 of determining if system 110 is in a pass state in which a pass event condition is met. System 110 is in the pass state when the low rail pressure cusum 514 is less than the LRP trip threshold 518. If the pass event condition is not met, method 400 may further include step 432 as described above with respect to DFHRP 352.

FIGS. 5A-6B each depict a chart showing exemplary parameter values of the fuel delivery monitoring system 110 when the fuel delivery monitoring system 110 is operating. FIGS. 5A-5B depict a low pressure monitoring chart 500 and FIGS. 6A-6B depict a high pressure monitoring chart 600. The low pressure monitoring chart 500 illustrates the low pressure parameter values (e.g., DFLRP 350) discussed above and the high pressure monitoring chart 600 illustrates the high pressure parameter values (e.g., DFHRP 352) discussed above. The x-axis of charts 500, 600 represents time elapsed in seconds. The left y-axis represents rail pressure in megapascals (MPa). The right y-axis represents engine speed in rotations-per-minute (rpm), a quantity of fuel injected by a fuel injector 122 in cubic millimeters (mm³), and the unitless cusum (e.g., LRPCusum 514 or HRPCusum 614).

Mapped relative to the left y-axis, each of charts 500, 600 include a desired rail pressure line 502, 602, a measured (e.g. actual) rail pressure line 504, 604, a desired filtered rail pressure line 506, 606 (herein referred to as DFLRP line 506 and DFHRP line 606), a rail pressure error line 508, 608 (e.g., the desired rail pressure subtracted from the measured rail pressure), a cusum error line 510, 610 (e.g., the measured rail pressure line 504, 604 subtracted by respective DFLRP line 506 or DRHRP line 606). Each of the aforementioned lines being a function of time. For example, desired rail pressure lines 502, 602 may illustrate the desired rail pressure (e.g., desired rail pressure 304) calculated by desired rail pressure module 228. Measured rail pressure line 504, 604 may illustrate the actual rail pressure (e.g., actual rail pressure 308) retrieved from common rail pressure sensor 212. DFLRP line 506 may illustrate the desired filtered low rail pressure (e.g., DFLRP 350) calculated by filtered desired rail pressure module 236. Similarly, DFHRP line 606 may illustrate the desired filtered high rail pressure (e.g., DFHRP 352) calculated by module 236. Rail pressure error line 508, 608 may illustrate rail pressure error (e.g., rail pressure error 325 calculated by difference node 324) as a function of time. In chart 500, cusum error line 510 may illustrate the difference between measured rail pressure line 504 and DFLRP line 506, and, in chart 600, cusum error line 610 may illustrate the difference between measured rail pressure line 604 and DFHRP line 606.

Mapped relative to the right y-axis, each of charts 500, 600 include an engine speed line 512, 612, a respective cusum line (e.g., LRPCusum 514 of chart 500 or HRPCusum 614 of chart 600), and an amount of fuel injected line 516, 616 (e.g., the amount of fuel injected by injectors 122). Moreover, each chart 500, 600 may include a trip threshold 518, 618 (e.g., LRP trip threshold 518 or HRP trip threshold 618). Similar to above with respect to the left y-axis, the aforementioned lines of the right y-axis are functions of time. In exemplary embodiments, engine speed line 512, 612 may illustrate engine speed retrieved from engine speed sensor 214. The amount of fuel injected line 516, 616 may illustrate the amount of fuel injected by injectors 122 (e.g., amount of fuel injected 310). LRPCusum 514 may be a summation (in other words, a running total) of cusum error line 510 and HRPCusum 614 may be a summation of cusum error line 610.

FIG. 5A depicts system 110 in a pass state where LRPCusum 514 remains below trip threshold 518 for the entire illustrated period. LRPCusum 514 remains approximately at zero for most of the duration because the measured rail pressure line 504 is greater than the DFLRP line 506 except at approximately eleven seconds where the measured rail pressure line 504 is less than DFLRP line 506. As illustrated in FIG. 5A, LRPCusum 514 begins to increment at approximately eleven seconds because the error between lines 504, 506 (e.g., measured rail pressure line 504 by DFLRP line 506) is less than zero as discussed with respect to step 422 of method 400. Moreover, LRPCusum 514 begins to decrement to zero at approximately twelve seconds because the error between lines 504, 506 is greater than zero.

FIG. 5B depicts system 110 in a trip state where at least one point of LRPCusum 514 exceeds LRP trip threshold 518. As illustrated, LRPCusum 514 increments to and exceeds LRP trip threshold 518 because the error between lines 504, 506 is generally less zero and thus LRPCusum 514 generally increments over the duration. Upon meeting LRP trip threshold 518, ECM 220 may output one or more of shutdown signal 240, reset/suspend signal 242, or trip signal 244.

Similar to FIG. 5A, FIG. 6A depicts system 110 in a pass state where HRPCusum 614 remains below trip threshold 618 (shown in FIGS. 6A-6B). HRPCusum 614 remains at approximately zero for the duration because the measured rail pressure line 604 is generally less than DFHRP line 506. At approximately three seconds, HRPCusum 614 begins to increment because the error between lines 604, 606, (e.g., measured rail pressure line 604 subtracted by DFHRP line 606) is greater than zero. HRPCusum 614 beings to decrement to zero at approximately four seconds because the error between lines 604, 606 is less than zero.

FIG. 6B depicts system 110 in a trip state where at least one point of HRPCusum 614 exceeds HRP trip threshold 618. As illustrated, HRPCusum 614 increments to and exceeds HRP trip threshold 618 because the error between lines 604, 606 is generally greater than zero and thus HRPCusum 614 generally increments over the duration. Upon meeting HRP trip threshold 618, ECM 220 may output one or more of shutdown signal 240, reset/suspend signal 242, or trip signal 244.

### Industrial Applicability

The systems and methods disclosed herein may be applied to any system that supplies pressurized fuel to one or more fuel injectors, such as an industrial machine having an internal combustion engine that allows the machine to perform work, move within a work site, generate electrical power, etc. Suitable industrial machines include, as examples, power generating systems (e.g., gensets), mining machines, hauling machines (e.g., haul trucks for mining, off-highway trucks, etc.), earthmoving machines, paving machines, and others. The analysis of the pressure signal may be performed using an ECM 220 located on the machine, or by an ECM 220 at a remote location (e.g., offsite) for monitoring one or a plurality of machines that each include a fuel system.

The disclosed system and method may be configured to identify low health or component failures by monitoring for low pressure events and for high pressure events within the system by comparing the measured rail pressure to a low rail pressure moving threshold and a high rail pressure moving threshold. The moving thresholds may continuously or periodically be adjusted during operation with a filter factor of a low pass filter retrieved based on an amount of fuel injected and a rail pressure error. Prior methods and systems may suspend or disable fuel pressure monitoring during transient conditions to prevent issuance of false-positive trip signals. The disclosed system may be configured to monitor the high rail pressure moving threshold and the low rail pressure moving threshold during transient conditions so that the actual rail pressure may be continuously monitored throughout operation of a machine including the disclosed system. The disclosed system may aid in monitoring for engine health and leak detection.

It will be apparent to those skilled in the art that various modifications and variations can be made to the disclosed method and system without departing from the scope of the disclosure. Other embodiments of the method and system will be apparent to those skilled in the art from consideration of the specification and practice of the apparatus and system disclosed herein. It is intended that the specification and examples be considered as exemplary only, with a true scope of the disclosure being indicated by the following claims and their equivalents.

1. A system for monitoring fuel rail pressure, the system comprising:
an internal combustion engine;
a plurality of fuel injectors configured to inject fuel into the internal combustion engine;
a fuel rail configured to provide the fuel to the plurality of fuel injectors;
a rail pressure sensor configured to detect a pressure of the fuel within the fuel rail; and
a controller configured to:
determine a rail pressure based on a signal from the rail pressure sensor;
determine at least one pressure threshold;
calculate a pressure error between the rail pressure and the at least one pressure threshold;
determine a high pressure condition based on the pressure error, wherein the high pressure condition includes a trip state or a pass state, wherein the high pressure condition is determined to be the trip state when the pressure error exceeds a trip threshold; and
issue a signal to control a fuel injector of the plurality of fuel injectors in response to determining that the high pressure condition is the trip state, wherein the signal is configured to cause the fuel injector to shutdown.

2. The system of claim 1, wherein the at least one pressure threshold includes a moving pressure threshold, the controller being configured to adjust the moving pressure threshold.

3. The system of claim 1, wherein the at least one pressure threshold includes a high rail pressure moving threshold determined with the controller based on a high rail pressure filter factor, wherein the controller is configured to retrieve the high rail pressure filter factor based on an amount of fuel provided by the plurality of fuel injectors and the pressure error.

4. The system of claim 3, wherein the controller is configured to retrieve the high rail pressure filter factor from one or more filter factor maps.

5. The system of claim 3, wherein the high rail pressure filter factor is a filter coefficient for a low pass filter.

6. The system of claim 1, wherein the controller is configured to determine a desired rail pressure, wherein the at least one pressure threshold includes a high rail pressure moving threshold, wherein the controller is configured to calculate the high rail pressure moving threshold based on a desired filtered rail pressure calculated at least based on a summation of the desired rail pressure and a positive predetermined offset.

7. The system of claim 6, wherein the controller is configured to continuously update the high rail pressure moving threshold based on one or more parameter values.

8. The system of claim 7,
wherein the controller is configured to monitor and record variances of the rail pressure from the high rail pressure moving threshold and determine, based on the variances, if a predetermined threshold is exceeded, and
wherein the controller is configured to issue an alert when the predetermined threshold is exceeded.

9. The system of claim 8, wherein the controller includes a high rail pressure cusum based on the variances of the rail pressure of the rail pressure from the high rail pressure moving threshold.

10. The system of claim 9, wherein the controller is configured to issue an alert when the high rail pressure cusum exceeds the predetermined threshold and issue a pass signal when the high rail pressure cusum is below the predetermined threshold.

11. The system of claim 10, wherein the controller is configured to increment the high rail pressure cusum at a rate that is faster than a rate at which the controller is configured to decrement the high rail pressure cusum.

12. The system of claim 10, wherein the controller is configured to suspend the high rail pressure cusum when an amount of provided fuel to the plurality of fuel injectors is lesser than a predetermined amount of provided fuel.

13. The system of claim 10, wherein the controller is configured to reset the high rail pressure cusum if the high rail pressure cusum exceeds a predetermined high threshold.

14. The system of claim 1, wherein the controller is configured calculate a dynamic pressure threshold of the at least one pressure threshold based on a high rail pressure filter factor, a previous dynamic pressure threshold, the rail pressure, and a desired rail pressure.

15. The system of claim 1, wherein the controller is configured to issue an alert if the high pressure condition is the trip state.

16. A system for monitoring rail pressure, the system comprising:
an internal combustion engine;
a plurality of fuel injectors configured to inject fuel for the internal combustion engine;
a fuel rail configured to provide the fuel to the plurality of fuel injectors;
a rail pressure sensor configured to detect a pressure of the fuel within the fuel rail; and
a controller configured to:
determine a desired rail pressure;
determine a rail pressure error based on a rail pressure measured with the rail pressure sensor and the desired rail pressure;
calculate a high rail pressure moving threshold and a low rail pressure moving threshold;
calculate a difference between the rail pressure and one of the low rail pressure moving threshold and the high rail pressure moving threshold; monitor a cumulative difference based on the calculated difference between the rail pressure and one of the low rail pressure moving threshold and the high rail pressure moving threshold; and
reset or suspend monitoring of the cumulative difference when the internal combustion engine is in a transient state.

17. The system of claim 16, wherein the controller further configured to:
increment or decrement one or more rail pressure cusums based on the difference between the rail pressure and one of the low rail pressure moving threshold or the high rail pressure moving threshold; and
issue an alert when the one or more rail pressure cusums exceeds a predetermined threshold.

18. The system of claim 17, wherein the controller includes one or more trip thresholds, wherein the controller is configured to issue a trip signal when one or more trip thresholds are exceeded by one or more rail pressure cusums.

19. A method for monitoring rail pressure, the method comprising:
receiving, from a pressure sensor, a rail pressure of a fuel injector of an internal combustion engine;
determining a desired rail pressure;
calculating a rail pressure error based on the rail pressure from the rail pressure sensor and the desired rail pressure;
calculating a high rail pressure moving threshold and a low rail pressure moving threshold;
incrementing a high rail pressure numerical value when the difference of the rail pressure and the high rail pressure moving threshold is a positive value;
incrementing a low rail pressure numerical value when the difference of the rail pressure and the low rail pressure moving threshold is a negative value;
monitoring the high rail pressure numerical value and the low rail pressure numerical value;
determining whether the internal combustion engine is in a transient state;
when the internal combustion engine is in the transient state, suspending monitoring of the high rail pressure numerical value or resetting the high rail pressure value upon the high rail pressure numerical value exceeding a first trip threshold; and
when the internal combustion engine is in the transient state, suspending monitoring of the low rail pressure numerical value or resetting the low rail pressure value upon the low rail pressure numerical value exceeding a second trip threshold.

20. The method of claim 19, further comprising: generating an alert if at least one of the high rail pressure numerical value and the low rail pressure numerical value exceeds a predetermined threshold.
